(19) United States
(12) Patent Application Publication
(10) Pub. No.: US 2024/0231511 A1
(43) Pub. Date: Jul. 11, 2024

(54) POINTER IN VIRTUAL REALITY DISPLAY

(71) Applicant: INTERNATIONAL BUSINESS MACHINES CORPORATION, ARMONK, NY (US)

(72) Inventors: AKINOBU MORISHIMA, Tokyo (JP); SHO AYUBA, Tokyo (JP); CHISA KORIYAMA, Tokyo (JP); Kazuki Matsumaru, Tokyo (JP)

(21) Appl. No.: 18/151,493

(22) Filed: Jan. 9, 2023

(51) Int. Cl. G06F 3/0346

(52) U.S. Cl. CPC G06F 3/0346

(57) ABSTRACT

Embodiments of present invention provide a method for displaying a pointer in a virtual display. The method includes detecting an initial posture of a user controller device; determining an initial position of the pointer in the virtual display; calculating a conversion factor between a move-in-posture of the user controller device and a change-in-position of the pointer; detecting a first move in the posture of the user controller device; calculating a first change in the position of the pointer, the first change being independent of a distance between the user controller device and the virtual display; adding the first change to the initial position of the pointer to obtain a first position of the pointer; and displaying the first position of the pointer in the virtual display, thereby avoiding causing uncomfortable dissociation due a change in the distance between the user controller device and the virtual display.

### BACKGROUND

The present application relates generally to the field of virtual reality, and more particularly to method of displaying position of a pointer in a virtual display.

In a virtual reality (VR) setting, a user may want to interact with a virtual display such as, for example, to enter certain text through a virtual keyboard. In this case, the user would generally, while wearing a head-mounted display (HMD), point or move a cursor or a pointer to the virtual keyboard. The cursor or pointer is usually set on a straight extension line of a direction that is aimed at by a controller device, which the user is holding with his/her hand.

More particularly, the pointer position is defined by the location and angular position of the controller device and controlled by the movement of the controller device. Particularly, a move-in-posture of the controller device, that is, the move of a user's wrist angular position, is known to be the single movement that will influence the pointer position the most. In general, the pointer moves translationally on a vertical virtual display or keyboard while a user's wrist (and the controller device) moves rotationally. As a result, the relationship between the rotational move of the user's wrist and the translational move of the pointer may change from time to time, depending upon the distance between the user and the virtual keyboard among some other factors. This change in relationship may result in undesirable dissociation between user expected pointer movement and actual pointer movement.

### SUMMARY

Embodiments of present invention provide a method of displaying a pointer in a virtual display. The method may be computer-implemented and may include detecting an initial posture of a user controller device; determining an initial position of the pointer in the virtual display; calculating a conversion factor between a move-in-posture of the user controller device and a change-in-position of the pointer; detecting a first move in the posture of the user controller device; calculating a first change in the position of the pointer based on the first move and the conversion factor, the first change being independent of a distance between the user controller device and the virtual display; adding the first change to the initial position of the pointer to obtain a first position of the pointer; and displaying the first position of the pointer in the virtual display, thereby avoiding causing uncomfortable dissociation due a change in the distance between the user controller device and the virtual display.

According to one embodiment, the method may further include detecting a second move in the posture of the user controller device; calculating a second change in the position of the pointer based on the second move and the conversion factor; adding the second change to the first position of the pointer to obtain a second position of the pointer; and displaying the second position of the pointer in the virtual display.

In one embodiment, calculating the conversion factor includes calculating a range of move of the user controller device; deciding a range of change of the pointer in the virtual display; and calculating the conversion factor by dividing the range of change by the range of move. In one aspect, deciding the range of change of pointer in the virtual display includes picking the range of change from a look-up table based on a display type information of the virtual display.

In another embodiment, calculating the range of move of the user controller device includes receiving a scaling coefficient from the user controller device; and calculating the range of move by dividing a pre-determined range by the scaling coefficient.

According to another embodiment, the method may further include receiving a request from the user controller device; re-detecting the initial posture of the user controller device; re-determining the initial position of the pointer in the virtual display; and re-calculating the conversion factor between the move-in-posture of the user controller device and the change-in-position of the pointer.

In one embodiment, the first move in the posture of the user controller device is a rotational move of the user controller device, and the first change in the position of the pointer is a translational move of the pointer along the virtual display.

In another embodiment, the virtual display is a virtual keyboard, a virtual menu items, or a virtual interactive picture.

In yet another embodiment, the initial position of the pointer is at a central position of the virtual display.

Embodiments of present invention provide a non-transitory storage medium thereupon stored a set of computer-readable instructions that, when being executed by a computer, cause the computer to perform detecting an initial posture of a user controller device; determining an initial position of a pointer in a virtual display; calculating a conversion factor between a move-in-posture of the user controller device and a change-in-position of the pointer; detecting a first move in the posture of the user controller device; calculating a first change in the position of the pointer based on the first move and the conversion factor, the first change being independent of a distance between the user controller device and the virtual display; adding the first change to the initial position of the pointer to obtain a first position of the pointer; and displaying the first position of the pointer in the virtual display, thereby avoiding causing uncomfortable dissociation due a change in the distance between the user controller device and the virtual display.

Embodiments of present invention also provide a computing environment, which includes a processor set; a communication fabric; at least one volatile memory; a persistent storage; and a set of peripheral devices, where the persistent storage further includes an operating system and stores thereupon a virtual reality (VR) application program, the VR application program, when being executed by the computing environment, causes the computing environment to perform detecting an initial posture of a user controller device; determining an initial position of a pointer in a virtual display; calculating a conversion factor between a move-in-posture of the user controller device and a change-in-position of the pointer; detecting a first move in the posture of the user controller device; calculating a first change in the position of the pointer based on the first move and the conversion factor, the first change being independent of a distance between the user controller device and the virtual display; adding the first change to the initial position of the pointer to obtain a first position of the pointer; and displaying the first position of the pointer in the virtual display, thereby avoiding causing uncomfortable dissociation due a change in the distance between the user controller device and the virtual display.

### BRIEF DESCRIPTION OF THE DRAWINGS

The present invention will be understood and appreciated more fully from the following detailed description of embodiments of present invention, taken in conjunction with accompanying drawings of which:

FIG. 1 is a demonstrative illustration of a networked computer environment according to one embodiment of present invention;

FIG. 2 is an operational diagram of a virtual reality application for displaying a pointer in a virtual display according to one embodiment of present invention;

FIG. 3 is a demonstrative illustration of a user operating a user controller device in a virtual reality setting according to one embodiment of present invention;

FIG. 4 is a demonstrative illustration of a user operating a user controller device in a virtual reality setting according to another embodiment of present invention;

FIG. 5 is a demonstrative illustration of the move-in-posture of a user controller device;

FIG. 6 is a demonstrative illustration of the change-in-position of a pointer in a virtual display; and

FIG. 7 is an operational flow-chart of a virtual reality application for displaying a pointer in a virtual display according to one embodiment of present invention.

It will be appreciated that for simplicity and clarity purpose, elements shown in the drawings have not necessarily been drawn to scale. Further, and if applicable, in various functional block diagrams, two connected devices and/or elements may not necessarily be illustrated as being connected. In some other instances, grouping of certain elements in a functional block diagram may be solely for the purpose of description and may not necessarily imply that they are in a single physical entity, or they are embodied in a single physical entity.

### DETAILED DESCRIPTION

In the below detailed description and the accompanying drawings, various embodiments of structures and/or methods of present invention may be disclosed. However, it shall be understood that the present invention may be embodied in various other and/or different forms and thus shall not be construed as being limited to the particular illustrative embodiments demonstratively shown here. In the description, details of some well-known features and techniques may be omitted in order to avoid unnecessarily obscuring the disclosed embodiments.

It is to be understood that the singular forms of “a,” “an,” and “the” may include plural referents unless the context clearly dictates otherwise. For example, reference to “a component surface” may include reference to one or more of such surfaces unless the context clearly dictates otherwise.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

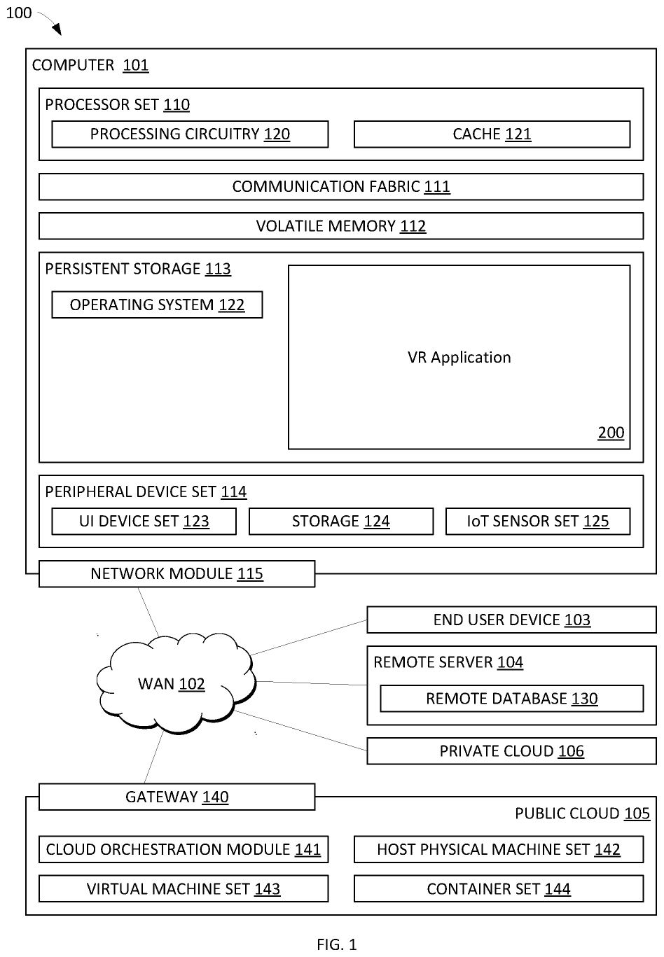

FIG. 1 is a demonstrative illustration of a networked computer environment according to one embodiment of present invention. Computing environment 100 contains an example of an environment for the execution of at least some of the computer code involved in performing the inventive methods, such as a virtual reality (VR) application 200, also referred to here as a block 200, that processes and handles the display of a virtual pointer in a virtual display such as, for example, a virtual keyboard, a set of virtual menu items, or a virtual interactive picture. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

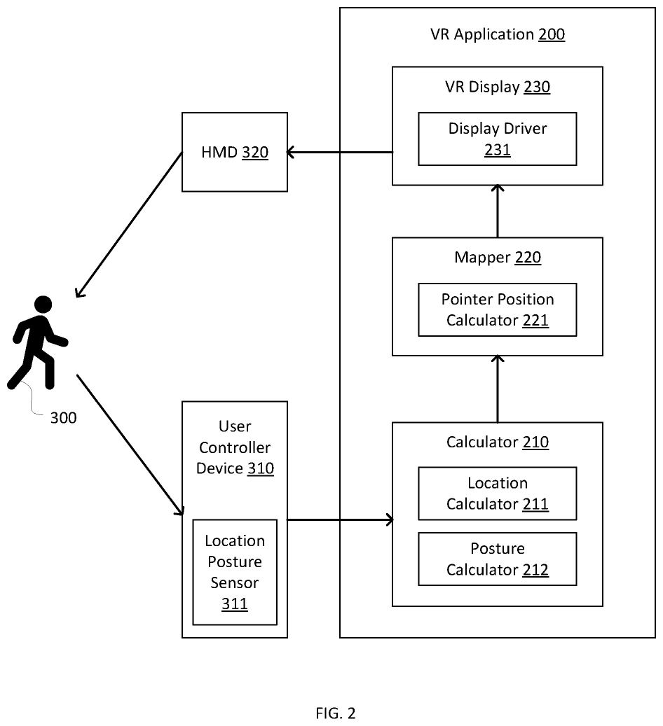

FIG. 2 is an operational diagram of a virtual reality application for displaying a pointer in a virtual display according to one embodiment of present invention. More particularly, embodiments of present invention provide a user 300, who holds a user controller device 310, interacting with a virtual display that he/she sees through a head-mounted display (HMD) 320. The HMD 320 may visualize the virtual display, which is at a virtual distance to the user, and a pointer on the virtual display. The pointer displayed on the virtual display may be controlled by the user controller device 310. The visualization of the pointer and the virtual display may be made through the use of a computer application software such as a VR application 200.

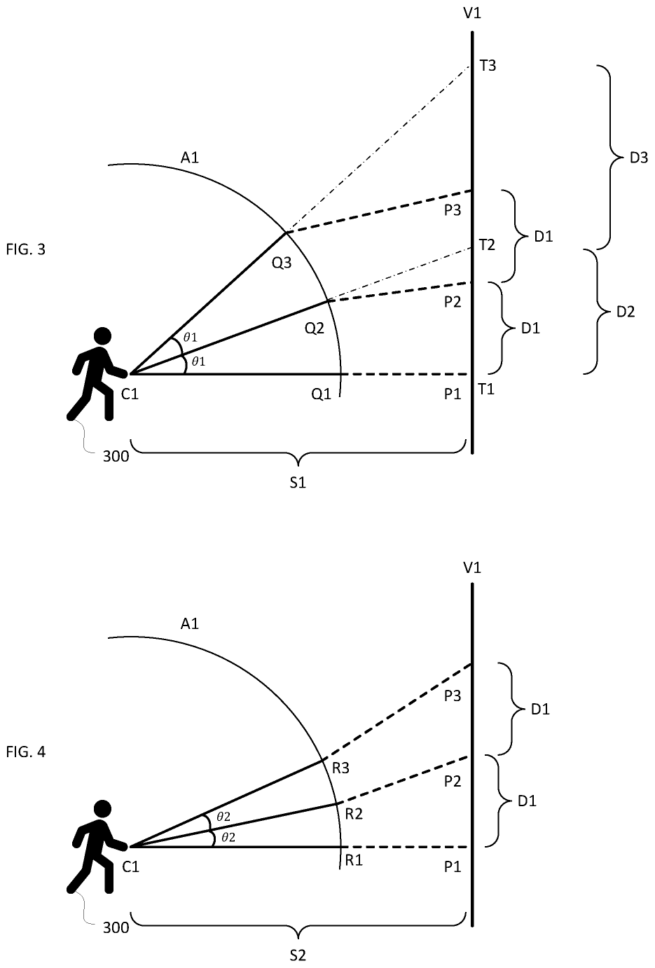

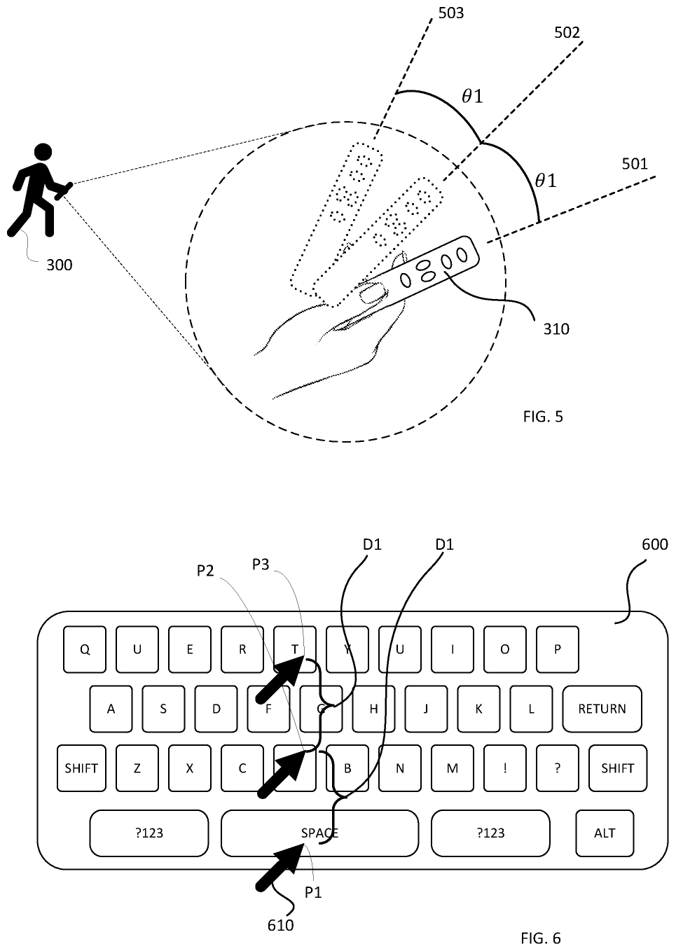

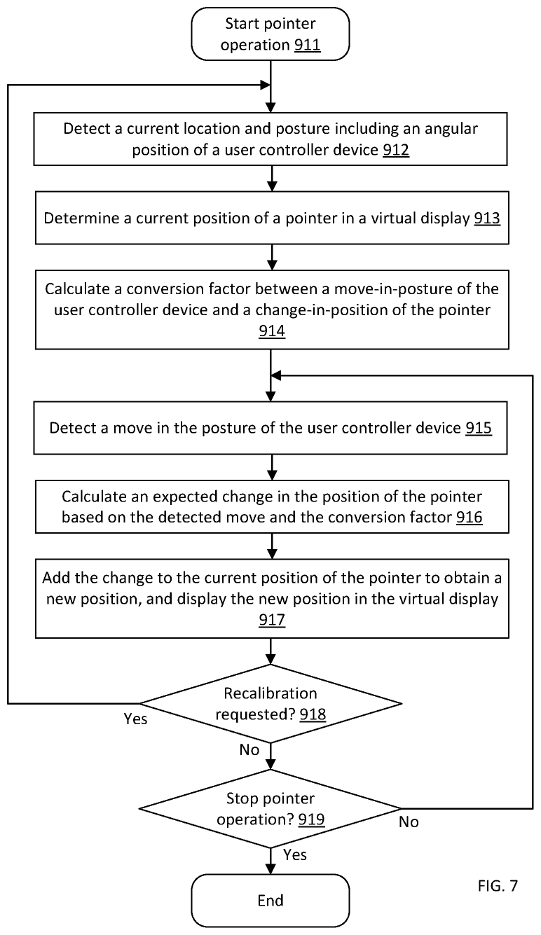

In the below detailed description, the operation of the VR application 200 will be explained in conjunction with reference to demonstrative steps illustrated in FIG. 7, which is a simplified operational flow-chart of the VR application 200 for displaying a pointer in a virtual display according to one embodiment of the present invention. In addition, FIG. 3 and FIG. 4 may be referenced when description is provided on how a user may interact with the pointer by providing rotational movement of the user controller device 310 to cause translational movement of the pointer in the virtual display; and FIG. 5 and FIG. 6 may be used to provide additional visual illustrations demonstrating the move-in-posture of the user controller device 310 and the change-in-position of the pointer in the virtual display.

Reference is now made back to FIG. 2. Specifically, embodiments of present invention provide enabling or starting the VR application 200 through a triggering signal that is usually initiated from the user controller device 310 such as, for example, by a press of a button, an audio input, or any other triggering mechanism made at the user controller device 310. However, embodiments of the present invention are not limited in this aspect. For example, the VR application 200 may get started through a change in setting or a turn of a switch made at the computing environment 100 (see FIG. 1) that executes the VR application 200, regardless the user controller device 310. Starting the VR application 200 may start the pointer operation (FIG. 7, step 911).

The user controller device 310 may include a location and posture sensor module 311, which provides constant and real-time location and posture information of the user controller device 310 for processing by the VR application 200. At the time when the VR application 200 is invoked or started, the sensor module 311 may detect a current location of the user, i.e., the current location of the user controller device 310. In addition, the sensor module 311 may detect the posture, such as an angular position, of the user controller device 310 (FIG. 7, step 912). Upon detection, information relating to the user controller device 310 are then provided to a calculator module 210 of the VR application 200. The calculator module 210 then calculates the location and angular position of the user controller device 310 through a location calculator 211 and a posture calculator 212 respectively. The calculated information of the user controller device 310, which includes location and angular position, are then forwarded to a mapper module 220 of the VR application 200 for determining a position of a pointer in a virtual display.

The mapper module 220 may determine a current position of the pointer in the virtual display (FIG. 7, step 913). For example, as a non-limiting example, when the VR application 200 is triggered by a turn of a switch in the computing environment 100 (see FIG. 1) rather than being triggered by the user controller device 310 or when the user controller device 310 is not pointing at the virtual display, the mapper module 220 may decide to position or place the pointer in an arbitrary position within the virtual display such as, for example, at a central position of the virtual display. For example, in one embodiment, when the virtual display is a virtual keyboard, the mapper module 220 may decide to place the pointer at a position P2 of the key-V in the virtual keyboard (see FIG. 6).

On the other hand, when the user controller device 310 is activated and pointing at the virtual display, the mapper module 220 may decide to place the pointer at a location towards which the user controller device 310 is pointing. The place where the user controller device 310 is pointing at may be calculated using a conversion factor, a scaling coefficient, and an angular position of the user controller device 310 as being described below in more details.

Reference is made to FIG. 3, which is a demonstrative illustration of a user operating a user controller device in a virtual reality setting according to one embodiment of the present invention. For example, a user 300 may situate at a location C1, away from a virtual display V1 by a virtual distance S1. The user controller device 310 held by the user 300 may possibly point at different directions such as, for example, the three directions represented by the three points Q1, Q2, and Q3 through a rotational movement of the user controller device 310. The three points Q1, Q2, and Q3 may situate along an arc A1 and may represent three directions that are represented by the solid lines originated from the location C1. The arc A1 has a center that overlaps with the location C1 of the user controller device 310. In the demonstratively illustrated example, the three points Q1, Q2, and Q3 are assumed to be equally spaced. In other words, the three directions represented by the three points Q1, Q2, and Q3 are angularly spaced and equally separated by an angle θ1.

Reference is briefly made to FIG. 5, which is a demonstrative illustration of the move-in-posture of a user controller device 310. In the enlarged picture of the user controller device 310 (held by a hand of the user), the user controller device 310 is demonstratively illustrated to be moving rotationally and pointing at three possible directions 501, 502, and 503 represented respectively by three dashed lines. The amount of rotational move may be measured by a first angular change from the direction 501 to the direction 502, and by a second angular change from the direction 502 to the direction 503. The first angular change may equal to the second angular change and both angular changes equal to θ1.

Reference is now made back to FIG. 3. According to embodiments of present invention, the posture of the user controller device 310 when pointing at the direction Q1 may correspond to a pointer position P1 at the virtual display V1; the posture of the user controller device 310 when pointing at the direction Q2 may correspond to a pointer position P2 at the virtual display V1; and the posture of the user controller device 310 when pointing at the direction Q3 may correspond to a pointer position P3 at the virtual display V1. According to embodiments of present invention, because the three points Q1, Q2, and Q3 are equally spaced, rotationally, by the angle θ1 along the arc A1, pointer positions P1, P2, and P3 are made to be equally spaced as well, translationally, by a distance D1 along the vertical direction of the virtual display V1. In other words, according to one embodiment of the present invention, equal rotational movement from Q1 to Q2 and then from Q2 to Q3 by the user controller device 310 may correspond to equal translational movement from P1 to P2 and then from P2 to P3 by the pointer respectively.

Reference is briefly made to FIG. 6, which is a demonstrative illustration of the change-in-position of a pointer in a virtual display. As a non-limiting example, a virtual keyboard 600 is demonstratively illustrated as a virtual display and a pointer 610 may change its position, in response to the move-in-posture of the user controller device 310, from position P1 to position P2, and from position P2 to position P3. The change-in-position of the pointer 610 may be translational, for example in a vertical direction as is demonstratively illustrated in FIG. 6, and the positions P1, P2, and P3 may be equally spaced by the distance D1 corresponding to the equal angular move θ1 in move-in-posture of the user controller device 310.

Reference is now made back to FIG. 3. According to embodiments of present invention, the move-in-posture from Q1 to Q2 by the user controller device 310 corresponds to the change-in-position from P1 to P2 by the pointer 610; and the move-in-posture from Q2 to Q3 by the user controller device 310 corresponds to the change-in-position from P2 to P3 by the pointer 610. According to one embodiment, a relationship between the change-in-position (such as D1) of the pointer 610 and the move-in-posture (such as θ1) of the user controller device 310 may be created and the relationship does not change with the change in distance S1 between the user 300 and the virtual display V1. In other words, the relationship between D1 and θ1 remains the same for different distance S1. By maintaining a same relationship between the translational move and the rotational move for different distance S1, embodiments of present invention provides a virtual reality setting that removes the uncomfortable or undesirable dissociation that is often associated with the change in distance S1 between the user 300 and the virtual display V1 and experienced by the user 300.

Embodiments of present invention provide determining the relationship through the use of a conversion factor and a scaling coefficient. In determining or calculating the conversion factor, embodiments of present invention provide first deciding a range of move-in-posture of the user controller device 310 and a range of change-in-position of the pointer 610 in the virtual display. In one embodiment, the range of move-in-posture may be decided by a pre-determined range of move-in-posture modified by a scaling coefficient. The pre-determined range of move-in-posture may be, for example, a range that may be considered as would-be comfortable for majority of users. For example, a range of move-in-posture of about 30 degrees or 45 degrees may be comfortable and deemed acceptable to majority of users. However, individual users may have different preferences and thus may like to have an option to choose or adjust the range of move-in-posture. This may be accomplished through the use of the scaling coefficient. For example, a user may choose a scaling coefficient of 0.5, 1.5, or 2 to adjust the range of move-in-posture of the user controller device 310. More specifically, assuming a pre-determined range of move-in-posture of 30 degrees, the use of a scaling coefficient of 0.5, 1.5, or 2 may adjust or modify the move-in-posture to be 60 degrees, 20 degrees, or 15 degrees respectively, by dividing the pre-determined range of move-in-posture by the scaling coefficient. This scaling coefficient may be set directly in the VR application 200 of the computing environment 100 or may be set in the user controller device 310, which is then sent to the VR application 200. The conversation factor may be calculated or determined by dividing the range of move-in-posture (may also be known as “range of move”) by the range of change-in-position (may also be known as “range of change”).

Reference is briefly made to FIG. 4, which is a demonstrative illustration of a user operating a user controller device in a virtual reality setting according to another embodiment of the present invention. More particularly, FIG. 4 illustrates a scenario or situation where a user 300 sets a scaling coefficient to be 2, thereby reducing the range of move-in-posture by nearly half because the user 300 may like to move his/her wrist less while still being able to use the user controller device 310 to control the change-in-position of the pointer 610. For example, instead of a range of move-in-posture from Q1 to Q3 (as in FIG. 3), the range is now divided by the scaling coefficient of 2 to be from R1 to R3 along the arc A1. Moving from Q1 to Q2 with an angular change of θ1 now becomes moving from R1 to R2 with an angular change of θ2, with θ2=θ1/2. Nevertheless, the rotational move from R1 to R2 of the user controller device 310 would still cause the pointer 610 to move from P1 to P2 translationally in a distance D1, and similarly the rotational move from R2 to R3 of the user controller device 310 would cause the pointer 610 to move similarly from P2 to P3 translationally also in a distance D1. This is despite the fact that the distance between the user 300 and the virtual display V1 may be now S2, different from S1 in FIG. 3. This is because, as being discussed above, the relationship between the translational move and the rotational move does not change with the distance between the user and the virtual display.

Reference is now made back to FIG. 3. In one embodiment, the range of change-in-position of the pointer 610 may be determined by information about the display type of the virtual display. For example, the virtual display may be a virtual keyboard, a set of virtual menu items, or a virtual interactive picture, etc. The information about the display type of virtual display may be provided by the VR application 200. In one embodiment, the display type to be used may be determined by the type of user controller device 310 that the user 300 has picked up, and thus the VR application 200 may in one embodiment receive such display type information from the user 300 through the user controller device 310. Based upon this display type information, the computing environment 100 may pick or choose, for example from a look-up table, a range of change-in-position to be used in connection with that display type. It is to be noted here that the range of change-in-position by the pointer may be dependent upon the display type only and may be independent from the distance S1 from the user controller device 310 and the virtual display V1. However, embodiments of present invention are not limited in this aspect and if preferred the distance S1 may be taken as one factor in determining the range of change-in-position for the pointer. Embodiments of present invention then provide calculating the conversion factor by dividing the range of change-in-position by the range of move-in-posture (FIG. 7, step 914).

FIG. 3 also demonstratively illustrates positions T1, T2, and T3 along the virtual display V1. T1, T2, and T3 are on straight extension lines of the directions represented by the points Q1, Q2, and Q3 that intersect with the virtual display V1, and represent pointer positions conventionally, without the embodiment of present invention. It is obvious that with an equal rotational move θ1 of the user controller device 310 from Q1 to Q2, and from Q2 to Q3, the pointer 610 may have a translational change-in-position from T1 to T2 with a distance D2, and from T2 to T3 with a distance D3 that is different from and larger than D2. Moreover, D2 and D3 may be dependent from the distance S1 between the user 300 and the virtual display V1. For example, the further away the user 300 from the virtual display V1, the bigger the distance D2 from T1 to T2 and distance D3 from T2 to T3. This makes stark contrast to the distance D1. According to embodiments of present invention, the distance D1 moved by the pointer 610 is independent of the distance S1 between the user 300 and the virtual display V1. The difference in D2 and D3 and particularly changes to D2 and D3 caused by change in S1 between the user 300 and the virtual display V1, as those in the currently existing art, may create dissociation of the user controller device 310 with the pointer 610, which often result in an uncomfortable, undesirable, and/or unpleasant user experience. Embodiments of present invention, by providing a distance D1 that is independent of the distance S1 between the user 300 and the virtual display V1, is able to avoid the uncomfortable, undesirable, or unpleasant dissociation due to a change in distance S1.

Reference is now made back to FIG. 2. After the pointer position calculator 221 of the mapper module 220 has determined the position of pointer, through calculation, using the conversion factor, scaling coefficient, and current angular position of the user controller device 310, the position information is passed onto a VR display module 230 such as a virtual keyboard, a set of virtual menu items, or an interactive picture. The VR display module 230 then applies a display driver 231 to cause the pointer 610 to be visualized in the HMD 320 wore by the user 300.

After the displaying of the initial position of the pointer 610 in the HMD 320, such as at a position P2 (see FIG. 3 and FIG. 6), the user 300 may cause a move-in-posture of the user controller device 310 in a rotational movement by rotating slightly his/her wrist that holds the user controller device 310. The move-in-posture may be a change from direction Q2 to direction Q3. Embodiments of present invention provide detecting such a move in the posture of the user controller device 310 (FIG. 7, step 915) through the location and posture sensor module 311; using the calculator module 210 to calculate an expected change in the position of the pointer 610 based upon the detected move, the conversion factor, and the scaling coefficient (FIG. 7, step 916); using the mapper module 220 to add the change-in-position to the current position of the pointer to obtain a new position of the pointer (FIG. 7, step 917); and using the display driver 231 to display the new position in the virtual display (FIG. 7, step 917) to change or update the displayed pointer position in the HMD 320.

The user 300 may continue to move the posture of the user controller device 310, through rotational movement, to control the change-in-position of the pointer 610 displayed in the virtual display such as the virtual keyboard 600. In this case, the above operational steps 915, 916, and 917 may be repeated to display the translational change-in-position of the pointer 610 until this pointer operation is interrupted or called to a stop (FIG. 7, step 919). During this repeated pointer operation, in one embodiment, a pointer recalibration request may be sent by the user 300 to the VR application 200, for example, through the use of the user controller device 310 (FIG. 7, step 918). In this case, this pointer operation may be returned back to a step that detects a current or initial location and posture of the user controller device 310 (FIG. 7, step 912) and the rest of steps may follow thereafter.

The descriptions above have been presented for the purposes of illustration of various embodiments of present invention. The terminology used herein was chosen to best explain the principles of the embodiments, practical application or technical improvement over technologies found in the marketplace, and to enable others of ordinary skill in the art to understand the embodiments disclosed herein. In addition, logic and/or operational flows depicted in the drawings do not require the particular order shown, or sequential order, to achieve desirable results. In addition, other steps may be provided, or steps may be eliminated, from the described logic and/or operational flows, and other components may be added to, or removed from, the described systems.

The disclosed embodiments are not intended to be exhaustive and present invention are not limited to these embodiments. Many modifications, substitutions, changes, and equivalents will now occur to those of ordinary skill in the art. Such changes, modification, and/or alternative embodiments may be made without departing from the spirit of present invention and are hereby all contemplated and considered within the scope of present invention. It is, therefore, to be understood that the appended claims are intended to cover all such modifications and changes as fall within the spirit of the invention.

What is claimed is:

1. A method for displaying a pointer in a virtual display, the method comprising:
detecting an initial posture of a user controller device;
determining an initial position of the pointer in the virtual display;
calculating a conversion factor between a move-in-posture of the user controller device and a change-in-position of the pointer;
detecting a first move in the posture of the user controller device;
calculating a first change in the position of the pointer based on the first move and the conversion factor, the first change being independent of a distance between the user controller device and the virtual display;
adding the first change to the initial position of the pointer to obtain a first position of the pointer; and
displaying the first position of the pointer in the virtual display, thereby avoiding causing uncomfortable dissociation due a change in the distance between the user controller device and the virtual display.

2. The method of claim 1, further comprising:
detecting a second move in the posture of the user controller device;
calculating a second change in the position of the pointer based on the second move and the conversion factor;
adding the second change to the first position of the pointer to obtain a second position of the pointer; and
displaying the second position of the pointer in the virtual display.

3. The method of claim 1, wherein calculating the conversion factor comprises:
calculating a range of move of the user controller device;
deciding a range of change of the pointer in the virtual display; and
calculating the conversion factor by dividing the range of change by the range of move.

4. The method of claim 3, wherein calculating the range of move of the user controller device comprises:
receiving a scaling coefficient from the user controller device; and
calculating the range of move by dividing a pre-determined range by the scaling coefficient.

5. The method of claim 3, wherein deciding the range of change of pointer in the virtual display comprises picking the range of change from a look-up table based on a display type information of the virtual display.

6. The method of claim 1, further comprising:
receiving a request from the user controller device;
re-detecting the initial posture of the user controller device;
re-determining the initial position of the pointer in the virtual display; and
re-calculating the conversion factor between the move-in-posture of the user controller device and the change-in-position of the pointer.

7. The method of claim 1, wherein the first move in the posture of the user controller device is a rotational move of the user controller device.

8. The method of claim 1, wherein the first change in the position of the pointer is a translational move of the pointer along the virtual display.

9. The method of claim 1, wherein the virtual display is a virtual keyboard, a virtual menu items, or a virtual interactive picture.

10. The method of claim 1, wherein the initial position of the pointer is at a central position of the virtual display.

11. A non-transitory storage medium thereupon stored a set of computer-readable instructions that, when being executed by a computer, cause the computer to perform:
detecting an initial posture of a user controller device;
determining an initial position of a pointer in a virtual display;
calculating a conversion factor between a move-in-posture of the user controller device and a change-in-position of the pointer;
detecting a first move in the posture of the user controller device;
calculating a first change in the position of the pointer based on the first move and the conversion factor, the first change being independent of a distance between the user controller device and the virtual display;
adding the first change to the initial position of the pointer to obtain a first position of the pointer; and
displaying the first position of the pointer in the virtual display, thereby avoiding causing uncomfortable dissociation due a change in the distance between the user controller device and the virtual display.

12. The non-transitory storage medium of claim 11, wherein the set of computer-readable instructions further cause the computer to perform:
detecting a second move in the posture of the user controller device;
calculating a second change in the position of the pointer based on the second move and the conversion factor; and
after adding the second change to the first position of the pointer to obtain a second position of the pointer, displaying the second position of the pointer in the virtual display.

13. The non-transitory storage medium of claim 11, wherein calculating the conversion factor comprises:
receiving a scaling coefficient from the user controller device;
calculating a range of move of the user controller device by dividing a pre-determined range by the scaling coefficient;
deciding a range of change of the pointer in the virtual display; and
calculating the conversion factor by dividing the range of change by the range of move.

14. The non-transitory storage medium of claim 11, wherein deciding the range of change of pointer in the virtual display comprises picking the range of change from a look-up table based on a display type information of the virtual display.

15. The non-transitory storage medium of claim 11, wherein the first move in the posture of the user controller device is a rotational move of the user controller device, and the first change in the position of the pointer is a translational move of the pointer along the virtual display.

16. A computing environment comprising:
a processor set; a communication fabric; at least one volatile memory; a persistent storage; and a set of peripheral devices,
wherein the persistent storage further includes an operating system and stores thereupon a virtual reality (VR) application program, the VR application program, when being executed by the computing environment, causes the computing environment to perform:
detecting an initial posture of a user controller device;
determining an initial position of a pointer in a virtual display;
calculating a conversion factor between a move-in-posture of the user controller device and a change-in-position of the pointer;
detecting a first move in the posture of the user controller device;
calculating a first change in the position of the pointer based on the first move and the conversion factor, the first change being independent of a distance between the user controller device and the virtual display;
adding the first change to the initial position of the pointer to obtain a first position of the pointer; and
displaying the first position of the pointer in the virtual display, thereby avoiding causing uncomfortable dissociation due a change in the distance between the user controller device and the virtual display.

17. The computing environment of claim 16, wherein the VR application program further causes the computer to perform:
detecting a second move in the posture of the user controller device;
calculating a second change in the position of the pointer based on the second move and the conversion factor; and
after adding the second change to the first position of the pointer to obtain a second position of the pointer, displaying the second position of the pointer in the virtual display.

18. The computing environment of claim 16, wherein calculating the conversion factor comprises:
receiving a scaling coefficient from the user controller device;
calculating a range of move of the user controller device by dividing a pre-determined range by the scaling coefficient;
deciding a range of change of the pointer in the virtual display; and
calculating the conversion factor by dividing the range of change by the range of move.

19. The computing environment of claim 16, wherein deciding the range of change of pointer in the virtual display comprises picking the range of change from a look-up table based on a display type information of the virtual display.

20. The computing environment of claim 16, wherein the first move in the posture of the user controller device is a rotational move of the user controller device, and the first change in the position of the pointer is a translational move of the pointer along the virtual display.
